(19) United States
(12) Patent Application Publication
(10) Pub. No.: US 2021/0010906 A1
(43) Pub. Date: Jan. 14, 2021

(54) RIM WIDTH ADJUSTING MECHANISM FOR TIRE TESTING MACHINE

(71) Applicant: KABUSHIKI KAISHA KOBE SEIKO SHO (KOBE STEEL, LTD.), Hyogo (JP)

(72) Inventors: Takashi SUMITANI, Takasago-shi, Hyogo (JP); Yu SUMIMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 16/979,466

(22) PCT Filed: Feb. 20, 2019
(86) PCT No.: PCT/JP2019/006279

§ 371 Date: Sep. 9, 2020

(30) Foreign Application Priority Data
Mar. 28, 2018 (JP) 2018-062135
Feb. 4, 2019 (JP) 2019-017899

(51) Int. Cl. G01M 17/02; B29D 30/00

(52) U.S. Cl. CPC G01M 17/021; B29D 2030/0066; B29D 30/0061

(57) ABSTRACT

Provided is a rim width adjustment mechanism for the tire testing machine, capable of being reduced in the number of components and miniaturized. The rim width adjustment mechanism includes a lower spindle for rotatably supporting the tire about a vertical axis through the lower rim, a plunger disposed in a through hole of the lower spindle to be raisable and lowerable to the lower spindle and having an upper end connectable to the upper spindle, and a rim width adjustment cylinder for adjusting the rim width by changing the protrusion length of the plunger beyond the lower spindle. The lower spindle is coupled to a cylinder side wall of the rim-width adjustment cylinder, thereby allowing a downward load applied to the lower spindle to be supported by the cylinder sidewall.

### TECHNICAL FIELD

The present invention relates to a mechanism for adjusting the rim width of a rim for test used in a tire testing machine such as a uniformity machine.

### BACKGROUND ART

Generally, the size of a tire is indicated by a bead width, a tire diameter and the like; there are also provided various sizes of wheels to which the tires are attached, depending on the tire diameter and the bead width. Hence, also for the tire testing machine, many kinds of rims for test are prepared according to the sizes of tires.

However, in the tire testing machine such as a uniformity machine, preparing a plurality of rims for test different not only in the rim diameter corresponding to the tire diameter but also in the rim width corresponding to the bead width from each other makes the number of required types of rims for test enormous, which is uneconomical. For this reason, in a conventional tire testing machine such as a uniformity machine, the rim for test is divided into an upper rim and a lower rim, the testing machine configured to change the vertical distance between the upper rim and the lower rim to thereby change the rim width of the rim. This enables the test for several types of tires having different bead widths to be executed with a common rim.

For example, the tire testing machine described in Patent Document 1 includes a rim width setting means that makes one of the pair of divided rims come relatively close to and separate from the other rim thereof to obtain an inter-rim distance corresponding to the bead width of the tire between the pair of divided rims. The rim width setting means allows tires having different bead widths to be attached to the common divided rim to thereby enable their uniformities to be inspected.

Specifically, the rim width adjustment mechanism described in Patent Document 1 includes a shaft support member, a shaft member, and a shaft lifting mechanism. The shaft support member is disposed on the lower side of the tire to support the tire through the lower rim and to rotate the tire about a vertical axis. The shaft member is disposed vertically movably inside the shaft support member and connectable to the lower portion of the upper rim. The shaft lifting mechanism changes the protrusion amount of the shaft member beyond the lower rim, thereby allowing the rim width formed between the lower rim and the upper rim to be adjusted.

In the rim width adjustment mechanism, the above-described shaft support member is vertically long and formed with a bore portion (hollow portion) on the inner lower side of the shaft support member, and the shaft lifting mechanism is disposed inside the bore portion. The shaft lifting mechanism is a hydraulic cylinder that is supplied with a hydraulic fluid to move vertically, that is, raise and lower, the shaft member.

The shaft lifting mechanism has a lower portion, which includes a bottom wall forming the bore portion (that is, the bottom wall of the bore portion), under which an adapter is provided, and the entire shaft support member is connected to a further hydraulic cylinder through the adapter. In other words, on the lower side of the bottom wall of the shaft lifting mechanism, the above-described bottom wall of the bore portion and the adapter exist. The rim width adjustment mechanism, therefore, has a vertically triple bottom wall.

Besides, the shaft support member has a cylinder side wall located outside the piston of the hydraulic cylinder that constitutes the shaft lifting mechanism; further outside the cylinder side wall, there exists a side wall that forms a bore portion. Thus, the rim width adjustment mechanism has inner and outer double side walls that are radially arranged.

Furthermore, the tire testing machine disclosed in Patent Document 1 requires a case as a force transmission member to interconnect the shaft support member and the shaft lifting mechanism (that is, the bottom wall and the side wall of the bore portion).

However, when the shaft support member includes such a case as the above-described force transmission member, the size of the entire tire testing machine is radially and vertically increased, involving problems in terms of securing space for the installation thereof and economic efficiency. Besides, installing the shaft lifting mechanism inside the above-described bore portion requires a sidewall and a bottom wall that form the bore portion, increasing the number of components. Furthermore, the vertical total length (overall height) of the rim width adjustment mechanism is increased by the thickness of the bottom wall of the bore portion. Such an increase in the overall height of the rim width adjustment mechanism ultimately increases the overall height dimension of the tire testing machine.

Furthermore, the side wall of the bore portion is required to function as a member for supporting the load, while the side wall has to be attached with a hydraulic pipe and the like to raise and lower the rim width adjustment cylinder as the shaft lifting mechanism; these complicate the structure of the rim width adjustment cylinder.

### CITATION LIST

### Patent Literature

[Patent Document 1] Japanese Unexamined Patent Application Publication No.10-160643

### SUMMARY OF INVENTION

The present invention has been made in view of the above problems, and an object thereof is to provide a rim width adjustment mechanism for a tire testing machine, the rim width adjustment mechanism being capable of being reduced in the number of components and miniaturized.

Provided is a rim width adjustment mechanism for a tire testing machine that is provided to a tire testing machine including a rim for supporting a tire, the rim having an upper rim and a lower rim that are separable from each other vertically, to adjust a rim width that is a vertical distance between the upper rim and the lower rim, the rim width adjustment mechanism comprising: an upper spindle having a lower end portion on which the upper rim is mountable, the upper spindle configured to rotate the upper rim and the tire supported by the upper rim about a vertical axis; a lower spindle having an upper end portion to which the lower rim is mountable, the lower spindle configured to support the lower rim so as to allow the tire supported by the lower rim to be rotated about the vertical axis and formed with a through hole penetrating the lower spindle vertically; a plunger disposed in the through hole of the lower spindle so as to be able to protrude upward beyond an upper end of the lower spindle and able to be raised and lowered relatively to the lower spindle to allow a protrusion length that is a length of a portion that protrudes beyond the upper end of the lower spindle in the plunger to be changed, the plunger having an upper end connectable to the upper spindle; and a rim width adjustment cylinder disposed below the lower spindle and coupled to the plunger to raise and lower the plunger so as to change the protrusion height of the plunger to thereby allow the rim width to be adjusted. The rim width adjustment cylinder includes a piston and a cylinder body that defines a cylinder chamber accommodating the piston so as to be able to be raised and lowered, and has a cylinder side wall surrounding the piston, the cylinder side wall being axially connected to a lower end of the lower spindle so as to allow the cylinder side wall to support a load applied to the lower spindle.

### BRIEF DESCRIPTION OF DRAWINGS

FIG. 1 is a plan view of a tire testing machine according to an embodiment of the present invention.

FIG. 2 is a front view of the tire testing machine from a direction perpendicular to a conveying direction of the tire.

FIG. 3 is a side view of the tire testing machine viewed along the conveying direction.

FIG. 4 is a sectional view showing a rim width adjustment mechanism of the tire testing machine.

FIG. 5 is a sectional view showing a rim width adjustment mechanism according to a modification of the embodiment.

FIG. 6 is a sectional view showing a rim width adjustment mechanism provided. in a conventional tire testing machine.

### DESCRIPTION OF EMBODIMENTS

Hereinafter, there will be described an embodiment of a tire testing machine 1 according to the embodiment of the present invention with reference to the drawings. The embodiments described below are examples of embodying the present invention, and the present invention is not limited to the examples. In the following description about the tire testing machine 1, the length of a conveying path of a tire with respect to a conveying direction of the tire corresponds to the total length of the tire testing machine 1. Horizontal direction intersecting the conveying path, more accurately substantially perpendicular to the conveying path, corresponds to the depth direction of the tire testing machine 1. The depth direction is also referred to as a left-right direction or a width direction. These directions are shown in the figures as appropriate,

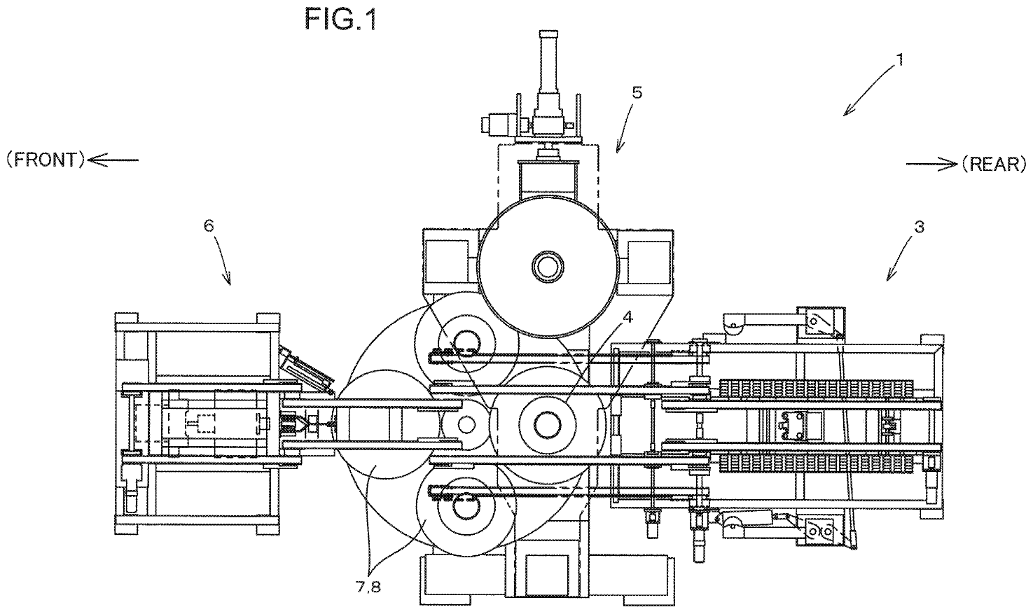

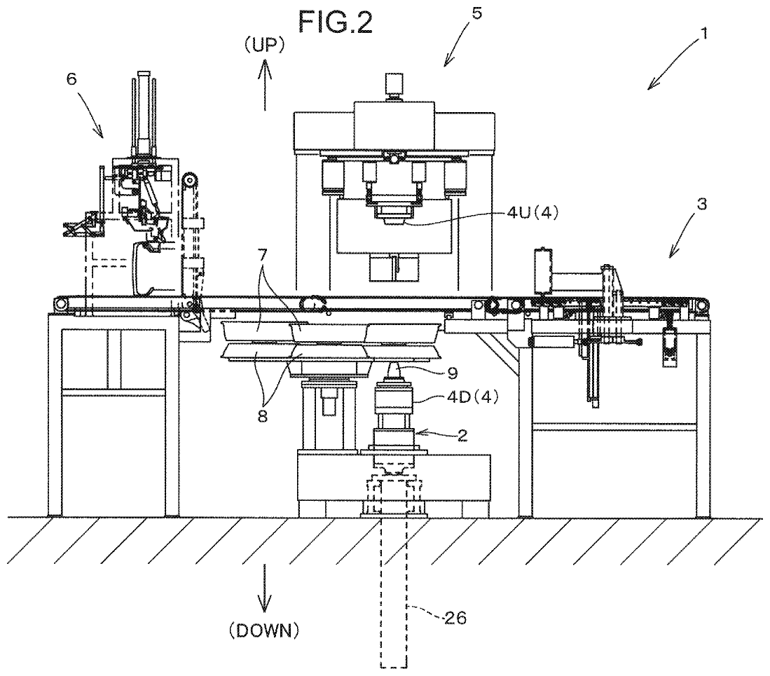

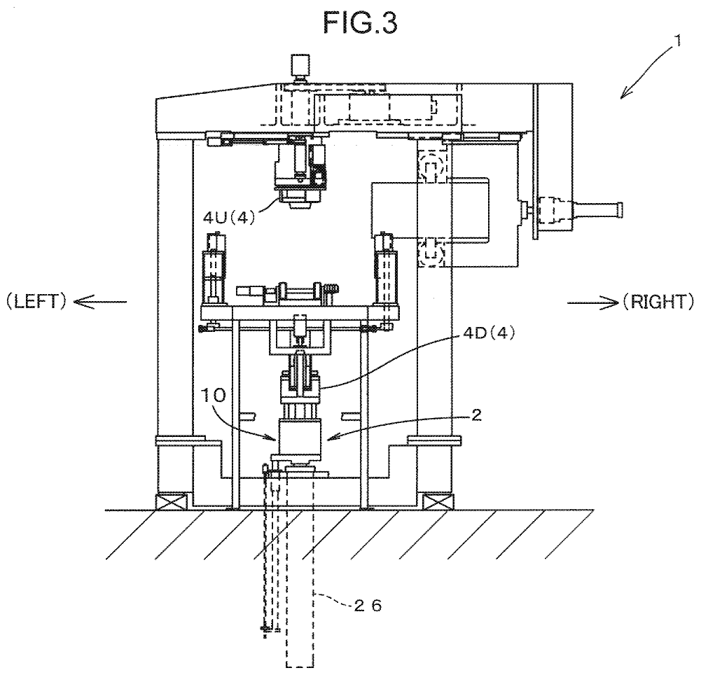

As shown in FIGS. 1 to 3, the tire testing machine 1 includes a lubrication section 3, a tire testing section 5, and a marking section 6. The lubrication section 3 applies a lubrication liquid to a bead portion of a tire while rotating the tire. The tire testing section 5 includes a spindle unit 4 that holds a tire applied with a lubrication liquid in the lubrication section 3 through a rim for test, and performs tire testing on the tire while rotating the tire held by the spindle unit 4 to detect a singular point existing in the tire. The marking section 4 applies marking on the circumferential position where the singular point exists in the tire.

The rim for test includes an upper rim 7 and a lower rim 8 on which the tire is mountable. The spindle unit 4 is constituted by an upper spindle 4U and a lower spindle 4D that support the upper rim 7 and the lower rim 8, respectively. The tire testing section 5 includes a rim width adjustment mechanism 2 that changes the interval between the upper and lower rims 7 and 8 to allow tires having different rim widths to be mounted.

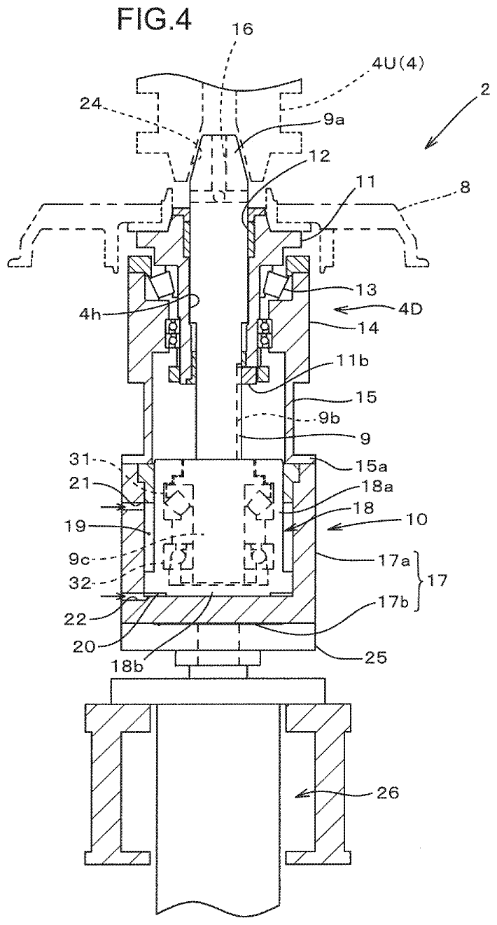

The rim width adjustment mechanism 2 includes the upper spindle 4U, the lower spindle 4D, a plunger 9 and a rim width adjustment cylinder 10 as shown in FIG. 4. The upper spindle 4U has a lower end portion on which the upper rim 7 is mountable, and is driven to be rotated with the upper rim 7 so as to rotate the upper rim 7 and the tire supported by the upper rim 7 about a vertical axis. The lower spindle 4D has an upper end portion on which the lower rim 8 is mountable and supports the tire through the lower rim 8 at a position below the tire. Specifically, the lower spindle 4D supports the lower rim 8 so as to allow the tire supported by the lower rim 8 to be rotated about a vertical axis. The lower spindle 4D has a through hole 4h which penetrates the lower spindle 4D vertically. Preferably, the through hole 4h is formed concentrically with the vertical center axis of the lower spindle 4D. The plunger 9 is disposed in the through hole 4h of the lower spindle 4D so as to be vertically displaceable, that is, able to be raised and lowered, relatively to the lower spindle 4D. The plunger 9 has an upper end 9a connectable to the upper spindle 4U. The rim width adjustment cylinder 10 raises and lowers the plunger 9 so as to change a protrusion length of the plunger 9 from the lower spindle 4D, that is, the length of the portion of the plunger 9 which portion protrudes upward beyond the upper end of the lower spindle 4D, to thereby adjust the rim width formed between the lower rim 8 and the upper rim 7 mounted on the upper spindle 4U.

As shown in FIG. 4, the lower spindle 41) is a substantially cylindrical member and has an upper end on which the lower rim 8 is mounted. The lower spindle 4D is disposed in a posture of standing upright so as to render the axial center of the lower spindle 4D vertical. Specifically, the lower spindle 4D includes a rim lock member 11, a bearing 13, a rotational support member 14, and an extension portion 15.

The rim lock member 11 is cylindrical and constitutes the upper end portion of the lower spindle 4D. The rim lock member 11 allows the lower rim 8 to he mounted on the rim lock member 11 while the lower rim 8 is placed thereon. The rim lock member capable of detachably supporting the lower rim 8. The rim lock member 11 has an inner peripheral surface enclosing the through hole 12, which penetrates the rim lock member 11 vertically and allows the above-described plunger 9 to be inserted in the through hole 12 vertically movably.

The rotational support member 14 is disposed around the rim lock member 11 and connected to the outer peripheral surface of the rim lock member 11 through the bearing 13. The rotational support member 14 has an inner diameter larger than the outer diameter of the rim lock member 11 and has a cylindrical shape with a vertical central axis. The rotational support member 14 is connected to the upper end portion of the rim width adjustment cylinder 10 through the extension portion 15. This enables the position of the rotational support member 14 relative to the foundation such as the floor to be fixed. In summary, in the lower spindle 4D, the rotational support member 14 supports the rim lock member 11 and further the lower rim 8 through the bearing 13 so as to allow them to be rotated about the vertical axis. The plunger 9 is disposed so as to penetrate the rim lock member 11 vertically.

As shown in FIG. 4, the plunger 9 is a vertically elongated rod-shaped member, being inserted in the center of the lower spindle 4D (specifically, the through hole 12 formed in the central side of the rim lock member 11) so as to be vertically movable. The upper end 9a of the plunger 9 has a tapered shape having a diameter decreased upward, while the lower end of the above-described upper spindle 4U has a recess 24 which is recessed so as to be opened upward as shown in FIG. 4. The tapered upper end 9a of the plunger 9 of the lower spindle 4D can be fitted into the recess 24 of the upper spindle 4U; through this fitting, the upper spindle 4U and the lower spindle 4D are interconnected so as to be rotated integrally with each other. A supply passage 16 is formed inside the upper end side portion of the plunger 9, allowing compressed air to be supplied into the tire through the supply passage 16.

The rim width adjustment cylinder 10 is disposed on the lower side of the plunger 9, being vertically expandable and contractable to direct the plunger 9 relatively to the lower spindle 4D to thereby allow the protrusion length of the plunger 9 to be adjusted. The expansion of the rim width adjustment cylinder 10 increases the protrusion length of the plunger 9. This increases the distance between the upper rim 7 and the lower rim 8 to allow a tire having a large bead width corresponding to a large rim width to he mounted on the tire testing machine 1. Conversely, the contraction of the rim width adjustment cylinder 10 reduces the protrusion length of the plunger 9, which allows a tire having a small bead width corresponding to a small rim width to be mounted on the tire testing machine 1.

As shown in FIG. 4, the rim width adjustment cylinder 10 includes a cylinder body 17 formed in a cylindrical shape having a bottom, and a piston 18 which is vertically movably loaded in the cylinder body 17.

The cylinder body 17 includes a cylindrical cylinder side wall 17a opened upward and downward and a cylinder bottom wall 17b closing the lower opening of the side wall. The cylinder side wall 17a and the cylinder bottom wall 17b enclose a cylinder chamber, which is an internal space of the cylinder body 17, and the piston 18 is vertically movably disposed in the cylinder chamber. In other words, the cylinder side wall 17a has such a cylindrical shape as to surround the piston 18.

The piston 18 partitions the cylinder chamber of the cylinder body 17 into the upper cylinder chamber 19 and the lower cylinder chamber 20. Each of the upper and lower cylinder chambers 19 and 20 can be supplied with a liquid working medium (a hydraulic fluid). Specifically, the cylinder side wall 17a is provided with an upper supply port 21 and a lower supply port 22. As indicated by the upper arrow in FIG. 4, the upper supply port 21 is formed at a position to allow the working medium to be supplied through the upper supply port 21 to the inside of the upper cylinder chamber 19 located above the piston 18. As indicated by the lower arrow in FIG. 4, the lower supply port 22 is formed at a position to allow the working medium to be supplied through the lower supply port 22 to the inside of the lower cylinder chamber 20 located below the piston 18.

By supply of working medium to the upper cylinder chamber 19 using a not-graphically-shown oil supply pump or the like, the piston 18 is lowered, reducing the protrusion length of the plunger 9 to reduce the rim width. Conversely, by supply of working medium to the lower cylinder chamber 20, the piston 18 is raised, increasing the protrusion length of the plunger 9 to increase the rim width.

The piston 18 is connected with the plunger 9 so as to allow the plunger 9 to be rotated relatively to the piston 18 about the central axis of the plunger 9. This allows the rim width adjustment cylinder 10 including the piston 18 to raise and lower the plunger 9 while allowing the plunger 9 to be rotated relatively to the rim width adjustment cylinder 10 with no rotation of the rim width adjustment cylinder 10 itself. Specifically, the piston 18 according to this embodiment receives the lower end portion 9c of the plunger 9 and rotatably holds the lower end portion 9c through vertically aligned bearings 31 and 32, More specifically, the piston 18 includes a cylindrical peripheral wall 18a and a bottom wall 18b. The peripheral wall 18a has a cylindrical shape surrounding the lower end portion 9c of the plunger 9 on the radially outer side thereof, and the bearings 31 and 32 are interposed between the inner peripheral surface of the peripheral wall 18a and the outer peripheral surface of the lower end portion 9c of the plunger 9. The bottom wall 18b is joined with the lower end of the peripheral wall 18a so as to close the lower opening of the peripheral wall 18a.

A large space is secured around the raised plunger 9. The reasons are as follows. The outer peripheral surface of the plunger 9 is formed with a key groove 9b indicated by a broken line in FIG. 4. Into this key groove 9b, a key 11b provided on the rim lock member 11 is fitted, thereby preventing the plunger 9 from being rotated while allowing the plunger 9 to be vertically displaced relatively to the rim lock member 11. Besides, there can be a case where a sensor for controlling the position of the plunger 9 is attached around the plunger 9 (e.g., a case where a plate is attached to the plunger 9 as a striker to detect the height position of the plunger 9 and connected to an external sensor) , and also in this case, a space is required around the plunger 9.

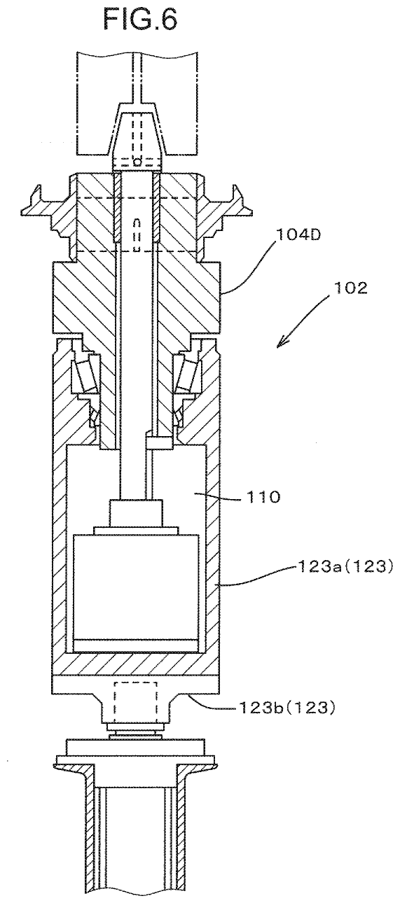

In the conventional rim width adjustment mechanism 102 shown in FIG. 6, the bore portion 123 that is a hollow portion is formed inside the lower portion of the vertically long lower spindle 104D, and the rim width adjustment cylinder 110 is housed inside the bore portion 123. This increases the radial and vertical dimensions of the apparatus by an amount corresponding to the side wall 123a and the bottom wall 123b to define the bore portion 123.

On the other hand, in the rim width adjustment mechanism 2 according to the present embodiment, the rim width adjustment cylinder 10 is not provided in a bore portion that is provided in the body of the lower spindle 4D, but the rim width adjustment cylinder 10 itself (in particular the cylinder side wall 17a) functions as a member for supporting the load applied to the lower rim 8 and the tire. Specifically, as shown in FIG. 4, the lower spindle 4D of the present embodiment extends continuously from the upper end to the lower end thereof, and the lower end is directly connected to the cylinder side wall 17a.

More specifically, the lower spindle 4D includes the extension portion 15 that further extends downward from the rotational support member 14 toward the lower end of the lower spindle 4D, the extension portion 15 having a lower end 15a. The lower end 15a, which corresponds to the lower end of the entire lower spindle 4D, is directly connected to the upper end of the cylinder side wall 17a by use of a bolt or the like. The lower end 15a of the extension portion 15 and the upper end of the cylinder side wall 17a have substantially the same shape when viewed axially. The extension portion 15 is mounted on the upper surface of the cylinder side wall 17a so as to superimpose the lower surface of the lower end 15a of the extension portion 15 on the upper surface of the cylinder side wall 17a. Specifically, the extension portion 15 and the cylinder side wall 17a are connected to each other by use of bolts or the like so as to be aligned vertically in. a state of having the same radial position.

Except for the lower end 15a, the extension portion 15 has a thickness and an outer diameter smaller than the thickness and the outer diameter of the rotational support member 14 in the radial direction, and the lower end 15a has a flange shape protruding outward beyond the portion of the extension portion 15 on the upper side of the lower end 15a. This allows the lower end 15a of the extension portion 1.5 to he axially fastened to the upper end of the cylinder side wall 17a with restriction of the outer diameter of the entire lower spindle 4D. In other words, the rotational support member 14 is provided with a radially large thickness to have high rigidity necessary for rotatably supporting the lower rim 8, while the thickness of the extension portion 15 extended from the rotational support member 14 is set to be small to allow the lower end 15a of the extension portion 15 to be fastened to the cylinder side wall 17a without increase in the radially outward protrusion dimension of the flange-like portion.

The vertical length, namely, the height dimension, of the extension portion 15 is substantially the same as or larger than the maximum vertical stroke of the piston 18 of the above-described rim width adjustment cylinder 10, in other words, the maximum expansion and contraction range of the plunger 9.

The tire testing machine 1 further includes a hydraulic cylinder 26 disposed below the rim width adjustment mechanism 2. The hydraulic cylinder 26 includes a cylinder body 17 to be fixed to the ground and a cylinder rod displaceable vertically to the cylinder body, and the upper end of the cylinder rod is connected to the cylinder bottom wall 17b of the cylinder body 17 in the rim width adjustment cylinder 10 through an adapter 25. The hydraulic cylinder 26 expands and contracts so as to raise and lower the entire rim-width adjustment mechanism 2 including the lower spindle 4D.

For performing the tire test in the above-described tire testing machine 1, the lower rim 8 is fixed to the rim lock member 11 of the lower spindle 4D, and then the rim width, which is the distance between the upper and lower rims 7 and 8, is adjusted by the rim width adjustment mechanism 2.

Specifically, adjusted is the protrusion length of the plunger 9, i.e., the length of the portion of the plunger 9 protruding upward beyond the upper end of the lower spindle 4D, by use of the rim width adjustment mechanism 2, and the lower spindle 4D with the thus adjusted protrusion length of the plunger 9 is raised by the extension of the hydraulic cylinder 26. The rise of the lower spindle 4D brings the tapered upper end 9a, which is a tip convex portion, of the plunger 9 into fitting with the recess 24, which is a tip recess portion formed in the lower end of the upper spindle 4U. The fitting of the upper spindle 4U and the plunger 9 with each other makes the interval between the upper and lower rims 7 and 8 equal to the rim width adjusted by the rim width adjustment mechanism 2, and the distance between the upper and lower rims 7 and 8 is thus adjusted to the bead width of the tire to he mounted thereon.

For example, for increasing the rim width, a liquid working medium is supplied to the lower cylinder chamber 20 of the rim width adjustment cylinder 10 in the above-described rim width adjustment mechanism 2, and the pressure of the working medium raises the piston 18 to increase the protrusion amount of the plunger 9 beyond the lower rim 8. By the increase in the protrusion, the lower spindle 4D being fitted to the upper spindle 4U is lowered. The rim width which is the vertical distance from the upper rim 7 to the lower rim 8 is thus enlarged.

Conversely, by supply of liquid working medium to the upper cylinder chamber 19 of the rim width adjustment cylinder 10, the pressure of the upper cylinder chamber 19 is raised to lower the piston 18. The fall of the piston 18 retracts the plunger 9 downward, and the lower spindle 4D fitted to the upper spindle 4U is raised by the amount of retraction of the plunger 9. The rim width is thereby reduced.

In the rim width adjustment mechanism 2 according to the present embodiment, the downward load due to the weight of the tire fitted in the lower rim 8 and the lower spindle 4D and the load other than the weight applied thereto are transmitted to the cylinder side wall 17a of the rim width adjustment cylinder 10 through the extension portion 15 of the lower spindle 4D, and further supported by the hydraulic cylinder 26 on the lower side through the adapter 25.

In the rim width adjustment mechanism 2 according to the present embodiment, the cylinder side wall 17a of the rim width adjustment cylinder 10 and the lower end 15a of the extension portion 15, that is, the lower end of the lower spindle 4D, are arranged vertically, not allowing a plurality of members to radially overlap at any height. Thus, the rim width adjustment mechanism 2 does not require the inner and outer double wall structure or triple wall structure around the rim. width adjustment cylinder 110 in the rim width adjustment mechanism 102 shown in FIG. 6. This allows the rim width adjustment mechanism 2 to have a simple structure and to have a radially and vertically small size.

Although the lower end 15a of the extension portion 15 as the lower end of the upper spindle 4U, in the above embodiment, is directly connected to the upper end of the cylinder side wall 17a, the rim width adjustment mechanism according to the present invention is not limited thereto.

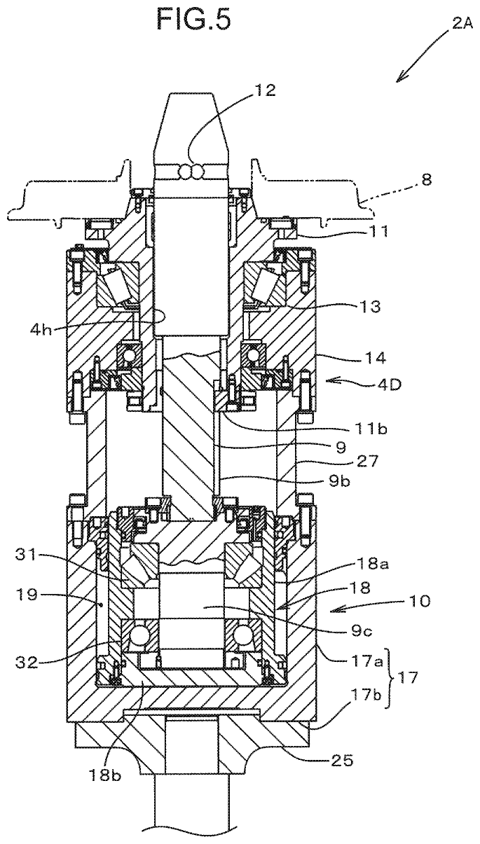

FIG. 5 shows a rim width adjustment mechanism 2A according to a modification of the embodiment. The rim width adjustment mechanism 2A includes, in place of the extension portion 15 of the lower spindle 4D according to the embodiment, a connection cylinder portion 27 interposed between the lower spindle 4D and the cylinder side wall 17a of the rim width adjustment cylinder 10.

The connection cylinder portion 27 is interposed between the lower spindle 4D and the cylinder side wall 17a to interconnect the lower end of the lower spindle 4D, the lower end of the rotational support member 14 in this embodiment, and the upper end of the cylinder side wall 17a. The connection cylinder portion 27 is a cylindrical member disposed on the upper side of the cylinder side wall 17a. The transverse section of the connection cylinder portion 27, being a cross section cut by a plane perpendicular to the central axis of the connection cylinder portion 27, has substantially the same shape as the transverse section of the cylinder side wall 17a.

The connection cylinder portion 27 has an upper surface capable of being abutted against the lower surface of the rotational support member 14 constituting the lower spindle 4D, being detachably connected to the lower spindle 4D by use of a bolt or the like. The connection cylinder portion 27 has a lower surface capable of being abutted against the upper surface of the cylinder side wall 17a, being detachably connected to the cylinder side wall 17a by use of a bolt or the like.

Similarly to the extension portion 15 according to the embodiment, the connection cylinder portion 27 also enables the weight of the tire and the rim to be supported by the cylinder side wall 17a of the rim width adjustment cylinder 10 through the connection cylinder portion 27, thereby eliminating the need for employing a double wall structure or triple wall structure around the cylinder body 17. This makes it possible, as in the above embodiment, to reduce the number of components and to miniaturize the rim width adjustment mechanism, in particular, to reduce the overall length thereof. Besides, the detachable connection of the connection cylinder portion 27 with the lower spindle 4D and the cylinder side wall 17a facilitates the assembly work and maintenance work of the rim width adjustment mechanism 2.

It should be noted that the embodiments disclosed herein are to be considered in all respects as illustrative and not restrictive. In particular, in the embodiment disclosed this time, matters that are not explicitly disclosed, such as operating conditions, operating conditions, various parameters, dimensions of components, weights, volumes, and the like, do not depart from the range normally practiced by a person skilled in the art, and values that can be easily assumed by a person skilled in the art are adopted.

The present invention has been made in view of the above problems, and an object thereof is to provide a rim width adjustment mechanism for a tire testing machine, the rim width adjustment mechanism being capable of being reduced in the number of components and miniaturized.

Provided is a rim width adjustment mechanism for a tire testing machine that is provided to a tire testing machine including a rim for supporting a tire, the rim having an upper rim and a lower rim that are separable from each other vertically, to adjust a rim width that is a vertical distance between the upper rim and the lower rim, the rim. width adjustment mechanism comprising: an upper spindle having a lower end portion on which the upper rim is mountable, the upper spindle configured to rotate the upper rim and the tire supported by the upper rim about a vertical axis; a lower spindle having an upper end portion to which the lower rim is mountable, the lower spindle configured to support the lower rim so as to allow the tire supported by the lower rim. to be rotated about the vertical axis and formed with a through hole penetrating the lower spindle vertically; a plunger disposed in the through hole of the lower spindle so as to be able to protrude upward beyond an upper end of the lower spindle and able to be raised and lowered relatively to the lower spindle to allow a protrusion length that is a length of a portion that protrudes beyond the upper end of the lower spindle in the plunger to he changed, the plunger having an upper end connectable to the upper spindle; and a rim width adjustment cylinder disposed below the lower spindle and coupled to the plunger to raise and lower the plunger so as to change the protrusion height of the plunger to thereby allow the rim width to be adjusted. The rim width adjustment cylinder includes a piston and a cylinder body that defines a cylinder chamber accommodating the piston so as to be able to be raised and lowered, and has a cylinder side wall surrounding the piston, the cylinder side wall being axially connected to a lower end of the lower spindle so as to allow the cylinder side wall to support a load applied to the lower spindle.

For example, the lower spindle preferably extends continuously from the upper end to a lower end thereof, the lower end being directly connected to an upper end of the cylinder side wall. This makes it possible to reliably transmit the load received by the lower spindle to the cylinder sidewall with the reduced number of components.

More specifically, it is preferable that the lower spindle includes a rotational support portion that rotatably supports the plunger, and an extension portion that extends downward from the rotational support portion and has an outer diameter and a radial thickness smaller than the outer diameter and the radial thickness of the rotational support portion, respectively.

Alternatively, the rim width adjustment mechanism may further include a connection cylinder portion that is detachably connected to the lower end of the lower spindle and the upper end of the cylinder side wall, respectively, to thereby interconnect the lower end of the lower spindle and the upper end of the cylinder side wall, while interposed between the lower end of the lower spindle and the cylinder side wall, to transmit the load applied to the lower spindle to the cylinder side wall.

1. A rim width adjustment mechanism for a tire testing machine that is provided to a tire testing machine including a rim for supporting a tire, the rim having an upper rim and a lower rim that are separable from each other vertically, to adjust a rim width that is a vertical distance between the upper rim and the lower rim, the rim width adjustment mechanism comprising:
an upper spindle having a lower end portion on which the upper rim is mountable, the upper spindle configured to rotate the upper rim and the tire supported by the upper rim about a vertical axis;
a lower spindle having an upper end portion to which the lower rim is mountable, the lower spindle configured to support the lower rim so as to allow the tire supported by the lower rim to be rotated about the vertical axis and formed with a through hole penetrating the lower spindle vertically;
a plunger disposed in the through hole of the lower spindle so as to be able to protrude upward beyond an upper end of the lower spindle and able to be raised and lowered relatively to the lower spindle to allow a protrusion length that is a length of a portion that protrudes beyond the upper end of the lower spindle in the plunger to be changed, the plunger having an upper end connectable to the upper spindle; and
a rim width adjustment cylinder disposed below the lower spindle and coupled to the plunger to raise and lower the plunger so as to change the protrusion length of the plunger to thereby allow the rim width to be adjusted, wherein
the rim width adjustment cylinder includes a piston and a cylinder body that defines a cylinder chamber accommodating the piston so as to be able to be raised and lowered, and has a cylinder side wall surrounding the piston, the cylinder side wall being axially connected to a lower end of the lower spindle so as to allow the cylinder side wall to support a load applied to the lower spindle.

2. The rim width adjustment mechanism for the tire testing machine according to claim 1, wherein the lower spindle extends continuously from the upper end to a lower end thereof, the lower end being directly coupled to an upper end of the cylinder side wall.

3. The rim width adjustment mechanism for the tire testing machine according to claim 2, wherein the lower spindle includes a rotational support portion rotatably supporting the plunger, and an extension portion extending downward from the rotational support portion and having an outer diameter and a radial thickness smaller than an outer diameter and a radial thickness of the rotational support portion, respectively.

4. The rim width adjustment mechanism for the tire testing machine according to claim 1, further comprising a connection cylinder portion that is detachably connected to the lower end of the lower spindle and the upper end of the cylinder side wall, respectively, to thereby interconnect the lower end of the lower spindle and the upper end of the cylinder side wall, while interposed between the lower end of the lower spindle and the cylinder side wall, to transmit the load applied to the lower spindle to the cylinder side wall.
